(19) United States
(12) Patent Application Publication
(10) Pub. No.: US 2015/0079868 A1
(43) Pub. Date: Mar. 19, 2015

(54) FLYING TOY

(71) Applicant: Nancy L. Stites, Orlando, FL (US)

(72) Inventor: Nancy L. Stites, Orlando, FL (US)

(21) Appl. No.: 14/027,796

(22) Filed: Sep. 16, 2013

(51) Int. Cl. A63H 27/00

(52) U.S. Cl. CPC A63H 27/02; A63H 27/001
USPC 446/34; 29/428

(57) ABSTRACT

A flying toy, a kit for assembling a flying toy, and method of constructing and launching a flying toy is shown and described. The flying toy may be used by dogs, cats, or other domesticated animals. The flying toy may include a tubular member configured to form a torus, simulated aircraft horizontal and vertical stabilizers attached to the torus to form a simulated aircraft empennage, and a simulated aircraft cockpit. The kit for constructing a flying toy may include four planar materials, one or more elastic filaments configured to form a loop, and filler material.

### FIELD OF THE INVENTION

This invention relates to the field of toys and, more particularly, toys suitable for dogs, cats, or other domesticated animals.

### BACKGROUND

Toys for playing with by domesticated dogs and cats have been known since dogs and cats animals were first domesticated. Video recordings of a dog chasing a ball or frisbee, or of a cat playing with a ball of yarn, are ubiquitous and demonstrate that the engagement of humans and pet animals playing with toys is virtually worldwide. This invention is a kit that may be assembled to make spring-assisted flying toy that may be launched by a human, and will be chased and played with by a dog or cat.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The assembled toy is an elastic loop that may be extended by stretching the loop and having, at the leading end, a rectangular double-width felt “cockpit” and, at the trailing end, an “empennage,” or tail section of an “airplane.” In a preferred embodiment, the body, of “fuselage” may be doughnut-shaped loop in which an elastic cord or rubber band is situated, along with a soft filler. The doughnut-shaped loop may have an external covering of any suitable covering that is flexible, compressible, and resistant to chewing. In a preferred embodiment, the cockpit may be filled with a filler or stuffing, and the empennage may be constructed of felt, although any suitable soft and flexible material may be used. It is preferable that any material used for the flying toy be non-toxic, and have sufficient strength to be resistant to chewing.

The components for making the flying toy may be provided in a kit, or may be constructed from items found in many homes, although some sewing may be necessary or desirable. In a preferred embodiment, the actual pieces to be used in the flying toy may be provided. In other embodiments, the kit may comprise patterns for cutting the various parts from a sheet of felt or other suitable material. Elastic cord or rubber bands may also be provided, along with filler material.

The assembled toy may be “launched” by placing the finger of one hand within the loop, preferably behind or near the back of the “cockpit,” while the other hand grasps the empennage or loop in the vicinity of the empennage and stretches the elastic fuselage. From the extended position, the hand grasping the empennage will release the toy, which will then spring away, forward, from the finger on the other hand, and will take flight. As the toy is neither designed nor intended to act as an airfoil, it may hurtle through the air in a tumbling or non-aerodynamic manner before landing, at which point it may be seized by an interested animal and either returned to the person who launched it, or may be taken elsewhere while the animal plays with it.

### BRIEF DESCRIPTION OF THE DRAWINGS

FIG. 1 shows an assembled flying toy.

FIG. 2 is a cutaway view showing the elastic element in the torus of the flying toy.

FIGS. 3a through 3g depict the components of the kit used to assemble the flying toy.

FIG. 4 shows the method of assembling the components from the kit for the flying toy.

FIG. 5 is a front perspective view of the assembled flying toy.

FIG. 6 depicts the assembled flying toy being readied for launch.

### DETAILED DESCRIPTION OF THE PREFERRED EMBODIMENTS

The following detailed description and the appended drawings describe and illustrate exemplary embodiments of the invention solely for the purpose of enabling one of ordinary skill in the relevant art to make and use the invention. As such, the detailed description and illustration of these embodiments are purely exemplary in nature and are in no way intended to limit the scope of the invention, or its protection, in any manner. It should also be understood that the drawings are not to scale and in certain instances details have been omitted, which are not necessary for an understanding of the present invention, such as conventional details of fabrication and assembly.

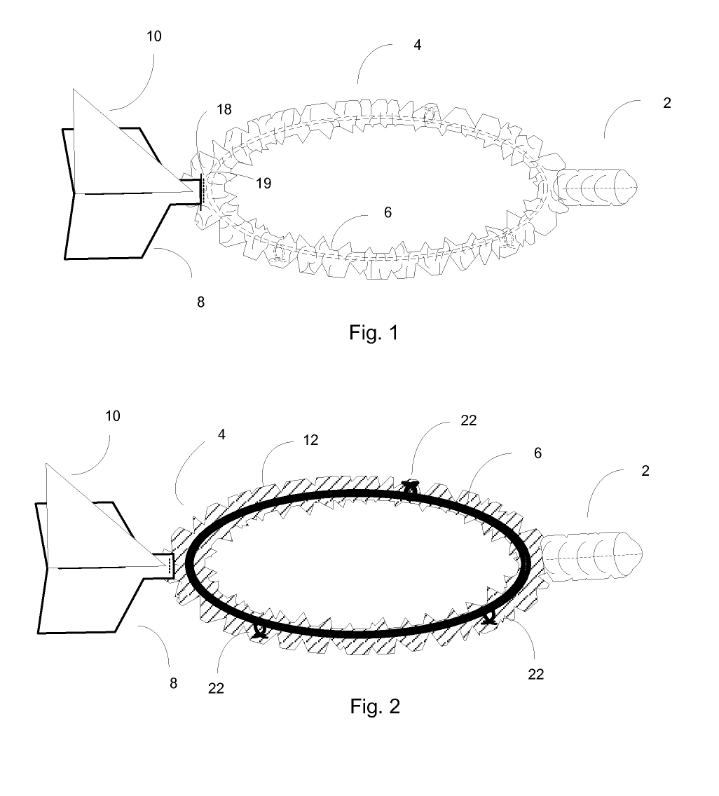

FIG. 1 is a perspective view of the flying toy of the invention. A “cockpit” 2 is fashioned from a sheet of material and is attached to the “fuselage” 4 by sewing or any other suitable attachment method. The fuselage 4 forms a flexible torus within which is an elastic cord 6, that may be a commercial elastic product or that may be one or more rubber bands attached at their ends to form a loop. An empennage is formed of a “tail” 10 and “horizontal stabilizers” 8. The horizontal stabilizer has a tab (not shown) that fits into slot 18 in torus 4. A stitch 19 may be taken to hold the stabilizer tab within torus body 4.

FIG. 2 depicts the flying toy with the torus 4 shown in cross section. An elastic cord 6 consists of three rubber bands tied end to end with knots 22. Alternatively, a single elastic cord may be used and may be provided as a continuous loop or may be provided as a single strand that must be attached end to end, by tying or some other common attachment method. In a preferred embodiment, a filler 12 is spread about the interior of the torus to provide shape to the torus. When the toy is to be launched, the person doing the launching may grab the empennage 8, 10 with one hand, extend a finger of the opposite hand to hold the inner part of the torus 4 just behind the “cockpit” 2, separate the two hands to create tension on the elastic 6 inside the torus 4 while holding the “cockpit” higher than the empennage, and release the toy by releasing the empennage. The elastic will snap the empennage toward the cockpit, and the energy of the elastic will be released in the form of forward motion of the toy. When a launching takes place in front of a dog or cat, a common response is often that the dog or cat will chase the flying toy.

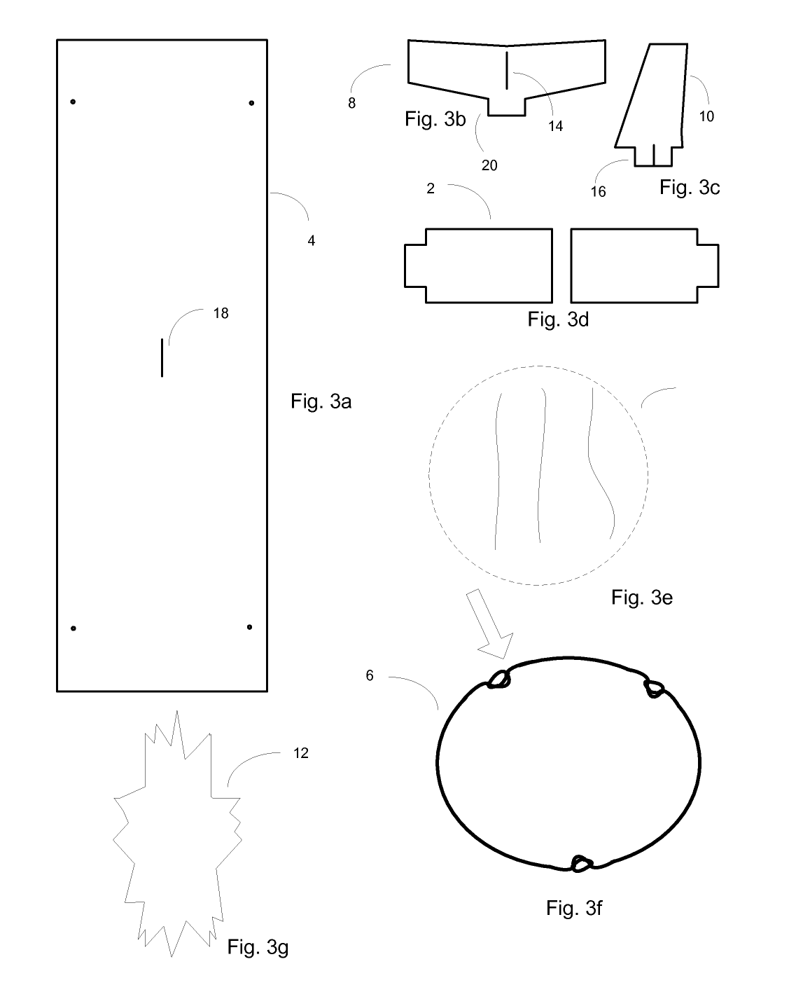

FIGS. 3a through 3g depict the separate, disassembled components of the flying toy that, in a preferred embodiment, would be included in a kit. The torus 4 is shown in FIG. 3a as it would be included in a kit. A slit 18 is provided for the tab 20 of the empennage to be fitted and secured with stitching. The horizontal tail 8 is depicted in FIG. 3b, and has a tab 20 that will secure the empennage to the torus 4, and a slit 14 through which tab 16 of the vertical stabilizer 10 will be fitted. The vertical stabilizer 10 is depicted in FIG. 3c. FIG. 3d comprises two identical pieces 2 that are stitched together form the “cockpit.” FIG. 3e shows three elastic strands which may be attached end-to-end to form a single circular elastic strand 6, as shown in FIG. 3f. Although any suitable attachment method will be acceptable, it is contemplated that the elastic strands will be rubber bands that may be tied end-to-end. Alternatively, any complete elastic loop may be used, and it is not required that separate strands be attached end-to-end. A filler 12 is shown in FIG. 3g, and may be used to provide substance to the torus 4 and a portion may also be used to fill out the “cockpit” 2.

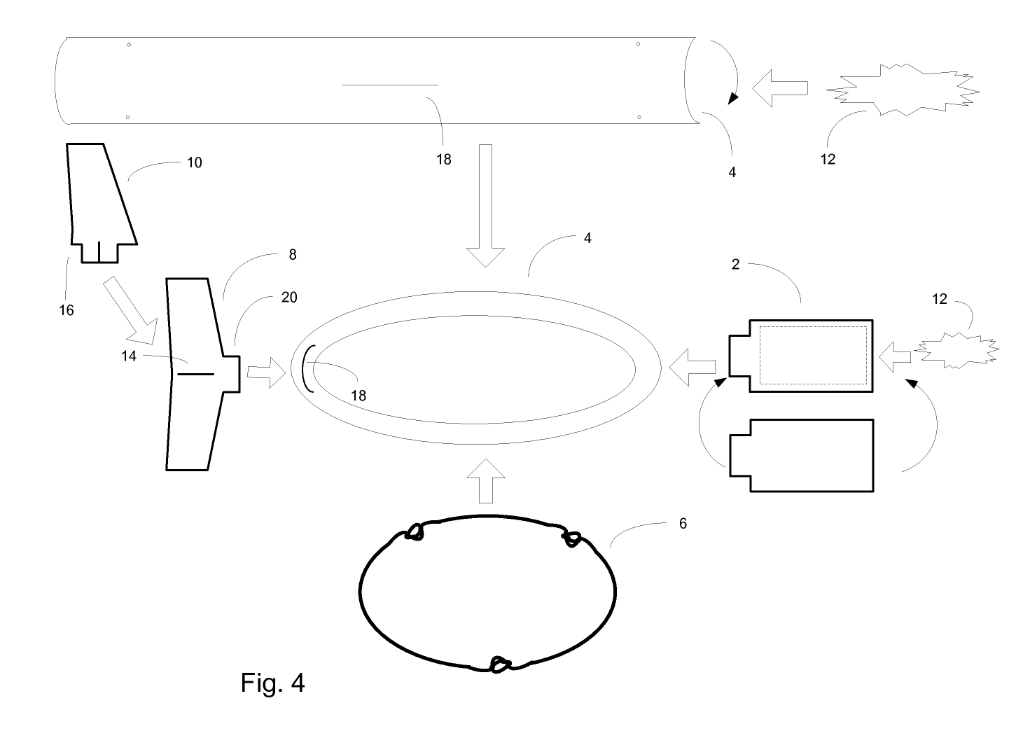

The method of assembly of the kit is depicted in FIG. 4. In FIG. 4, the unassembled torus 4 is folded to make a torus into which filling 12 will be introduced. The assembled torus 4 will then be fitted around elastic strand 6 to enclose the elastic strand wholly within the torus. A “cockpit” 2 will be fashioned of two identical pieces that will be stitched together to form a volume into which additional filling 12 may be stuffed. The empennage is assembled using a vertical stabilizer 10 and fitting tab 16 into slot 14 of the horizontal stabilizer 8. Tab 20 from the horizontal stabilizer 8 is then fitted into slit 18 in torus 4, and may be secured there with stitching. As thus assembled, a flying toy is able to be launched.

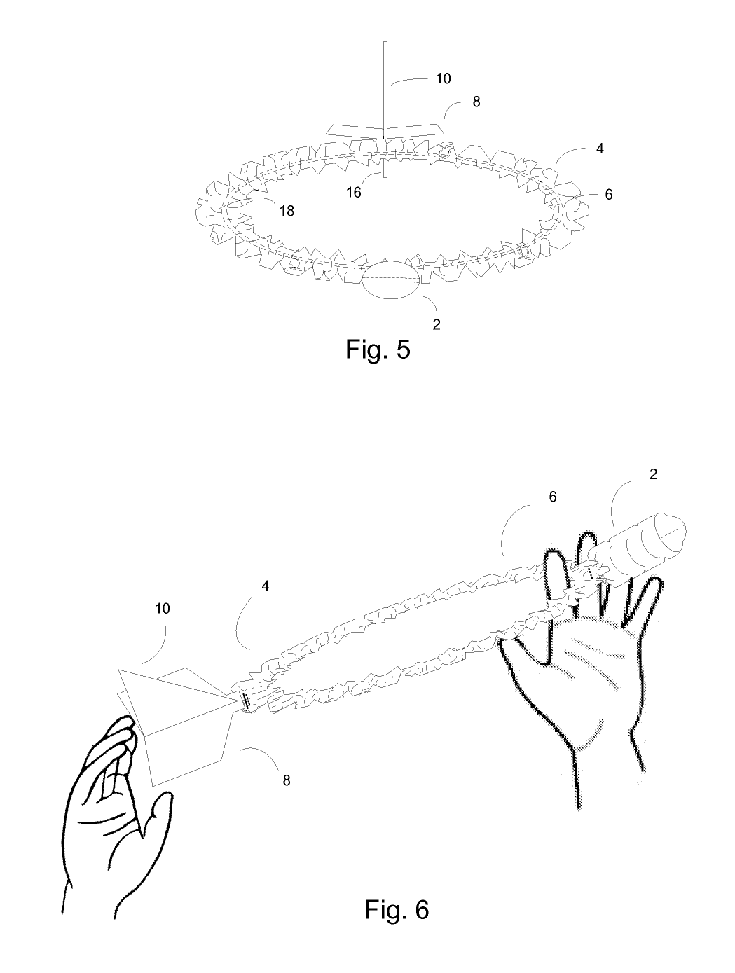

FIG. 5 depicts a front view of the assembled flying toy, and FIG. 6 shows the toy being readied for launch. In FIG. 6, a first hand grasps the empennage while a second hand raises a finger to hold the front part of the elastic torus. As the first hand grasps and pulls the empennage, the elastic stretches and tension is placed on the toy and the second hand that is resisting the tension. When the first hand releases the empennage, the elastic contracts, and the toy is launched upwards and forward, and will follow an arc until it hits the ground or is intercepted in mid-flight by an animal.

What is claimed is:

1. A kit to be assembled to create a flying toy comprising:
a planar first flexible material being rectangular in shape, said first flexible material being configurable to form a cylindrical member, said first flexible material having a slit parallel to a longer side of said rectangular shape;
a planar second material being in the shape of an aircraft horizontal stabilizer, said second material having a rectangular tab protruding at the front of said horizontal stabilizer and a slit in said second material extending perpendicular to said protruding rectangular tab;
a planar third material being in the shape of an aircraft vertical stabilizer, said third material having a rectangular tab protruding at the lower extremity thereof, said lower tab being configured to fit within said slit in said second material such that, when inserted in said slit, said vertical stabilizer will be generally perpendicular to said horizontal stabilizer;
a planar fourth material comprising one or more substantially rectangular pieces configured to form a tubular member having an open end, said member having protruding rectangular tabs at said open end, said protruding rectangular tabs being configured to fit within said slit in said first flexible material; and
one or more elastic filaments configured to form a loop.

2. The kit according to claim 1, wherein the planar fourth material is comprised of a singular piece folded on itself and joined at least at the long edges of said singular piece.

3. The kit according to claim 1, wherein the planar fourth material is comprised of two substantially identical pieces joined at the long edges.

4. The kit according to claim 3, wherein the two substantially identical pieces are joined by a stitching.

5. The kit according to claim 1, wherein the one or more elastic filaments are tied together, end-to-end, to form the loop.

6. The kit according to claim 1 further comprising filler material insertable into either the cylindrical member or the tubular member.

7. A flying toy comprising:
a tubular member configured to form a torus, said tubular member enclosing an elastic filament forming a loop;
a simulated aircraft horizontal stabilizer;
a simulated aircraft vertical stabilizer;
said simulated horizontal and vertical stabilizers being attached to form a simulated aircraft empennage, said simulated aircraft empennage being attached to said torus;
a simulated aircraft cockpit, said simulated aircraft cockpit being formed from a tubular member that is closed at both ends and attached at one end to said torus in a position substantially opposite the attachment of said simulated aircraft empennage.

8. The flying toy according to claim 7, further comprising a filler material enclosed by said tubular member.

9. The flying toy according to claim 7, further comprising filler a filler material enclosed by said simulated aircraft cockpit.

10. The flying toy according to claim 7, wherein the simulated aircraft empennage is attached to the torus by stitching.

11. The flying toy according to claim 7, wherein the simulated aircraft cockpit is attached to the torus by stitching.

12. The flying toy according to claim 7, wherein the elastic loop is comprised of a plurality of elastic filaments joined together end-to-end.

13. The flying toy according to claim 7, whereby said flying toy may be launched by holding a portion of said torus adjacent said simulated aircraft cockpit, expanding said elastic loop by pulling said torus at a position adjacent said simulated aircraft empennage, and abruptly releasing said torus from said position adjacent said simulated aircraft empennage.

14. A method of constructing and launching a flying toy comprising:
providing one or more elastic members to form an elastic loop;
providing a planar first flexible material, said first flexible material being rectangular in shape, the length of said rectangle being longer than the length of said elastic loop;
forming said first flexible material into a cylindrical member surrounding said elastic loop such that a portion of said elastic loop extends lengthwise within said cylindrical member;
inserting filler material into said cylindrical member;
configuring said cylindrical member to form a torus such that said elastic loop is completely enclosed within said torus;
creating a slit in said torus, said slit being parallel to the circumference of said torus;
providing a planar second material in the shape of an aircraft horizontal stabilizer, said second material having a rectangular tab protruding at the front of said horizontal stabilizer, and having a slit extending perpendicular to said protruding rectangular tab;
providing a planar third material in the shape of an aircraft vertical stabilizer, said third material having a rectangular tab protruding at the lower extremity thereof;
inserting said lower tab of said vertical stabilizer into said slit in said horizontal stabilizer and securing said lower tab such that said vertical stabilizer is generally perpendicular to said horizontal stabilizer;
inserting said protruding rectangular tab of said horizontal elevator into said slit in said torus and securing said protruding rectangular tab to said torus;
providing a planar fourth material comprising a tubular member having an open end with protruding rectangular tabs at said open end, placing filler material within said tubular member, and closing said tubular member near said tabs;
attaching said protruding rectangular tabs to said torus at a point on said torus approximately opposite said slit in said torus such that a secure connection is formed between said tubular member and said torus;
holding the interior area of said torus near said tubular member, extending the torus by stretching said elastic loop in a direction opposite said tubular member, and abruptly releasing said torus such that said elastic loop contracts and launches said toy away from said holding area.
